(19) United States
(12) Patent Application Publication
(10) Pub. No.: US 2007/0280982 A1
(43) Pub. Date: Dec. 6, 2007

(54) Antimicrobial compositions comprising hop acid alkali salts and uses thereof

(76) Inventors: Mitsunori Ono, Lexington, MA (US); Keiko Yamaguchi, Bethesda, MD (US); Naoto Yamaguchi, Bethesda, MD (US)

Correspondence Address: EDWARDS ANGELL PALMER & DODGE LLP, P.O. BOX 55874, BOSTON, MA, 02205, US

(21) Appl. No.: 11/731,764

(22) Filed: Mar. 29, 2007

Related U.S. Application Data
(60) Provisional application No. 60/787,384, filed on Mar. 29, 2006.

(51) Int. Cl. A23L 3/34; A01N 25/08

(52) U.S. Cl. 424/410; 422/28; 424/405; 426/532

(57) ABSTRACT

The invention features anti-microbial compositions comprising compositions of hop acid alkali metal salts and alkaline earth metal salts and methods of using them to inhibit microbial growth.

### CROSS-REFERENCE TO RELATED APPLICATIONS

This application claims the benefit of U.S. Provisional Application No. 60/787,384, filed Mar. 29, 2006, which is incorporated herein by reference in its entirety.

### BACKGROUND

Preservatives are added to many food products to retard product spoilage caused by mold, bacteria, fungi or yeast. Contaminated food products can cause serious illnesses that have the potential to affect large numbers of people. For example, in the 1980's listeriosis affected hundreds of people who consumed listeria infected meat products. Particularly susceptible to the disease were pregnant women, fetuses, newborn and infant children, and adults with compromised immune systems. Although treatable with early diagnosis, untreated listeriosis exhibits a high mortality rate. In view of the serious risks associated with food borne illness, most food products are treated with a variety of chemical preservatives. Although the use of preservatives reduces the risk of food borne illness, studies have shown that a number of chemical preservatives act as carcinogens. Concerns about such food additives have caused consumers to turn to food products that do not contain chemical preservatives despite the risks associated with antimicrobial contamination.

Consumers demand safe wholesome products containing natural preservatives that do not contain chemical preservatives. Natural hop acids show strong antimicrobial activity. However, this activity is limited by their susceptibility to degradation by oxidation, light and acid catalyzed rearrangement.

### SUMMARY

The present invention provides antimicrobial compositions comprising one or more hop acid alkali metal or alkaline earth metal salts having increased stability relative to conventional hop acids and methods for producing these compositions.

In one aspect, the invention generally provides a method for preventing or inhibiting microbial growth in a product, the method comprising contacting the product with an effective amount of a hop acid salt selected from the group consisting of sodium, potassium, lithium, calcium, and magnesium thereby preventing or inhibiting microbial growth in the product. In one embodiment, the product is a food product, an industrial product or a home product. In another embodiment, the method increases the amount of time the product may be held in the absence of spoilage prior to consumption by a consumer relative to a product not subjected to the method. In yet another embodiment, the method increases the shelf life of the product relative to a product not subjected to the method. In yet another embodiment, the time or shelf life is increased by at least about six months, nine months, twelve months, eighteen months, twenty-four months, or thirty-six months. In yet another embodiment, the method increases stability of the hop acid salts or derivatives thereof or reduces degradation of the hop acids relative to a product not subjected to the method. In yet another embodiment, the amount of hop acids (or derivatives thereof) detected after six, nine, twelve, eighteen, twenty-four or thirty-six months is at least 75% of the amount of the hop acids or derivatives thereof applied.

In another aspect, the invention provides a method for preventing or inhibiting microbial growth on a surface, the method comprising contacting the surface with an effective amount of a hop acid salt selected from the group consisting of sodium, potassium, lithium, calcium, and magnesium thereby preventing or inhibiting microbial growth on the surface. In one embodiment, the method clean, sanitizes, or disinfects the surface (e.g., a wall, floor, ceiling, counter, machine, or other surface or equipment) present in an industrial (factory or food processing facility), commercial (e.g., office building, plane, train, automobile, restaurant, cafeteria, daycare center, food processing facility), or clinical setting (e.g., a hospital, medical office, clinic, health center, or laboratory). In another embodiment, the surface contacted is present in a dwelling, school, office building, plane, train, automobile, restaurant, cafeteria, or daycare center. In yet another embodiment, the surface contacted is a wall, floor, carpet, ceiling, counter, appliance, food preparation vessel, food storage vessel, or other equipment used in food preparation.

In another aspect, the invention provides a method of sanitizing or disinfecting a body part, the method comprising contacting the body part with an effective amount of a hop acid salt selected from the group consisting of sodium, potassium, lithium, calcium, and magnesium, thereby sanitizing or disinfecting the body part. In one embodiment, the body part (e.g., mammalian or avian) is skin, fur, hair, wool, feathers, an oral cavity, or any other organ. In another embodiment, the hop acid is formulated as a skin cleanser. In yet another embodiment, the skin is cleansed in preparation for surgery.

In another aspect, the invention provides a method for preventing or inhibiting a food borne disease, the method comprising contacting a food product with an effective amount of a hop acid salt selected from the group consisting of sodium, potassium, lithium, calcium, and magnesium. In one embodiment, the hop acid salt is added to the food product prior to, during, or after processing of the food product. In another embodiment, the contacting results in a food product comprising about 0.1 to 60 ppm or about 0.04 to 30 ppm hop acid salts.

In another aspect, the invention provides a method for preventing or inhibiting the growth of an airborne microbe, the method comprising contacting a surface with an effective amount of a hop acid salt selected from the group consisting of sodium, potassium, lithium, calcium, and magnesium.

In another aspect, the invention provides an antimicrobial composition comprising an effective amount of a hop acid alkali metal salt or alkaline earth metal salt or combinations thereof in a carrier or diluent. In preferred embodiments, the composition is formulated as a powder.

In another aspect, the invention provides an absorbent composition comprising an effective amount of a hop acid salt selected from the group consisting of sodium, potassium, lithium, calcium, and magnesium. In one embodiment, the composition is suitable for absorbing bodily fluids, secretions, or excretions. In another embodiment, the composition is selected from the group consisting of a wound dressing, a medical sponge, a hemostatic article, an adhesive bandage, a wound packing, an internal vascular closure packing, an external vascular closure dressing, a swellable absorbent article, a fibrotic wound packing article, a diaper, and a feminine hygiene product.

In another aspect, the invention provides a method for inhibiting food spoilage by contacting a food product with the composition of any previous aspect. In one embodiment, the food product is selected from the group consisting of meat, fish, vegetable, grain, and pasta. In another embodiment, the meat is poultry, beef, lamb, pork, or a processed meat product. In yet another embodiment, the vegetable is a pickled vegetable. In yet another embodiment, the grain is raw or cooked rice. In yet another embodiment, the pasta is dried, fresh, or cooked. In yet another embodiment, the fish is raw, cooked, or a processed fish product. In yet another embodiment, the processed fish product is fish paste. In another embodiment, the food product is animal feed formulated for mammalian or avian consumption.

In another aspect, the invention provides a method of preventing the growth of Listeria monocytogenes in a food product, the method comprising contacting the medium with an effective amount of a hop acid alkali metal salt. In one embodiment, the food product contains 0.1 to 60 or 0.04 to 30 ppm hop acid alkali metal salts. In another embodiment, the contacting results in a food product comprising about 0.1-60 ppm or 0.04 to 30 ppm hop acid alkali metal salts. In another embodiment, the food product contains about 4 to 50 ppm hop acid alkali metal salts.

In another aspect, the invention provides a food packaging material comprising hop acid alkali metal salt or an alkaline earth metal salt. In one embodiment, in the method increases stability of the hop acid salts or derivatives thereof. In another embodiment, the packaging material is selected from the group consisting of polymer films, food paper, paper wrapping, paper, or meat casings.

In various embodiments of any of the above aspects, the hop acid salts are hop acid alkali metal salts (e.g., sodium, potassium, lithium), alkaline earth metal salts (e.g., calcium, magnesium) or derivatives thereof. Such salts may soluble in water or largely insoluble. Hop acid salts may be used alone or in any combination. In various embodiments of the above aspects, the hop acids detected after three, six, nine, twelve, eighteen, twenty-four, or thirty-six months is at least 50%, 75%, 80%, 90%, or even 95% of the amount of the hop acids or derivatives thereof applied. In other embodiments of the above aspects, the hop acid salt is a water-soluble alkali metal salt or a water insoluble alkaline earth metal salt. In other embodiments, at least about 1%-90% (e.g., 0.1%, 1%, 2%, 5%, 10%, 25%, 75%, 80% to 90%) of the hop acids are in the metal salt form or in the free acid form. In still other embodiments of the above aspects, the hop acid salt is formulated as a water soluble or water insoluble solid, liquid, emulsion, slurry, or powder. In still other embodiments, the composition contains 0.1% to 90% (e.g., 0.1%, 1%, 2%, 5%, 10%, 25%, 75%, 80% to 90%) of a hop acid alkaline earth metal salt. In still other embodiments of the above aspects, the antimicrobial is present in a diluent, such as ethanol, water or other aqueous solution. In still other embodiments, the composition contains 0.1%, 1%, 2%, 5%, 10%, 25%, 75%, 80% or 90% of hop acid salts. In preferred embodiments, the composition is formulated as a powder (e.g., a powder that contains hop beta acid sodium salts or potassium salts and a maltodextrin carrier). The composition contains 1% to 90% of hop beta acid sodium salts. In still other embodiments, the hop acids are lipid encapsulated (e.g., in hydrogenated soy bean oil). In still other embodiments, the powder contains carbohydrate, proteinaceous, fiber, silica, or plant or animal originated resin as a carrier. In still other embodiments, the fiber is cellulose, hydroxymethyl cellulose, hydroxyethyl cellulose, hydroxypropyl cellulose, or hypomellose. In still other embodiments, the carrier is maltodextrin, cluster dextrin, cyclodextrin, glucose, corn starch, corn syrup solid, arabic gum, calaginan, or inuline. In still other embodiments, the diluent contains water, a water-miscible organic solvent, or a combination thereof. In still other embodiments, the diluent contains ethanol, cremophor, dimethylsulfoxide (DMSO), dimethylformamide (DMF), isopropanol (IPA) or glycerol. In still other embodiments, the composition contains a surfactant. In still other embodiments, the carrier is an alkyl poly(ethylene oxide) by “alkyl poly(ethylene oxide) is meant a terminal hydroxyl, sulfate, or carboxylate group were grafted at the surface of poly(ethylene),” alkyl polyglucoside, sugar ester, fatty alcohol, or combinations thereof. In still other embodiments, the composition further contains at least one known antibacterial agent. In still other embodiments, the known antibacterial agent is ethanol, glycine, sodium actetate, sorbic acid, sodium dehydroacetate, sodium lactate, sodium benzoate, p-hydroxy benzoate, ε-polylysine, milt protein, lysozyme, or any plant derived antimicrobial component.

Exemplary bacteria susceptible to inhibition with a composition of the invention include any one or more of bacterial pathogens including, but are not limited to, Aerobacter, Aeromonas, Acinetobacter, Actinomyces israelli, Agrobacterium, Bacillus, Bacillus antracis, Bacteroides, Bartonella, Bordetella, Bortella, Borrelia, Brucella, Burkholderia, Calymmatobacterium, Campylobacter, Citrobacter, Clostridium, Clostridium perfringers, Clostridium tetani, Cornyebacterium, corynebacterium diphtheriae, corynebacterium sp., Enterobacter, Enterobacter aerogenes, Enterococcus, Erysipelothrix rhusiopathiae, Escherichia, Francisella, Fusobacterium nucleatum, Gardnerella, Haemophilus, Hafnia, Helicobacter, Klebsiella, Klebsiella pneumoniae, Legionella, Leptospira, Listeria, Morganella, Moraxella, Mycobacterium, Neisseria, Pasteurella, Pasturella multocida, Proteus, Providencia, Pseudomonas, Rickettsia, Salmonella, Serratia, Shigella, Staphylococcus, Stentorophomonas, Streptococcus, Streptobacillus moniliformis, Treponema, Treponema pallidium, Treponema pertenue, Xanthomonas, Vibrio, and Yersinia.

The details of one or more embodiments of the invention are set forth in the description below. Other features, objects, and advantages of the invention will be apparent from the description and from the claims.

### Definitions

By “alpha acid” is meant any one or more compounds collectively known as humulones and derivatives thereof that can be isolated from hops plants or hop products or synthetically produced. Exemplary alpha acids include, but are not limited to, isocohumulone, isoadhumulone, isoadhumulone, rhoisoalpha acids (e.g., rhoisohumulone, rhoisocohumulone, and rhoadhumulone), tetrahydroisoalpha acids (e.g., tetrahydroisohumulone, tetrahydroisocohumulone and tetrahydroadhumulone), hexahydroisoalpha acids (e.g., hexahydroisohumulone, hexahydroisocohumulone and hexahydroadhumulone). In one embodiment, an isolated alpha acid salt is substantially free of the compounds that naturally accompany the alpha acid in a hop plant or plant extract.

By “anti-microbial composition” is meant any composition that prevents, inhibits, slows, or reduces the growth, proliferation, or survival of a microbe (e.g., bacteria, fungus (e.g., mold), protozoa, virus).

By “beta acid” is meant any one or more compounds collectively known as lupulones and derivatives thereof that can be isolated from hops plants or hop products or synthetically produced. Exemplary isolated beta acids include, but are not limited to, lupulone, adlupulone, colupulone, tetrahydro lupulone, tetrahydroadlupulone, tetrahydrocolupulone and their derivatives, including hexahydro beta acids and tetrahydro beta acids, or any beta acid derivative. In one embodiment, an isolated beta acid salt is substantially free of the compounds that naturally accompany the beta acid in a hop plant or plant extract.

By “body part” is meant any tissue or organ of a mammalian or avian organism. Exemplary body parts include, but are not limited to, skin, hair, fur, epidermis, feathers, wool, hide, the oral cavity, including but not limited to, the lips, tongue, and teeth.

By “conventional hop acid” is meant a hop acid susceptible to degradation.

By “dwelling” is meant any human residence.

By “food preservative” is meant an agent that tends to prevent or retard deterioration (e.g., spoilage) of a food product when contacted with the product relative to an uncontacted food product. Desirably, products containing such agents have increased shelf-life relative to untreated products.

By “effective amount” is meant an amount of a compound that prevents, inhibits, slows, stabilizes, or reduces the growth of a microbe. An effective amount of the compound described above may range from about 0.1 ppm to about 1000 ppm. Effective amounts may vary depending on the microbe to be inhibited, the application method, as well as the possibility of co-usage with other agents.

By “food preservation” is meant any method that reduces the risk that a food product will be contaminated with an undesirable microbe.

By “food product” is meant any composition intended for human, mammal, or avian consumption.

By “food spoilage” is meant any alteration in a food product that makes it less palatable. Exemplary alterations include changes in taste, smell, texture or appearance. Spoiled food may or may not be toxic.

By “food borne disease” is meant any disease caused by consumption of food contaminated by a microbe or a microbial toxin. A food borne disease may be caused by infection of a host with a microbe or by action of a toxin produced by the microbe either in the food or in the host.

By “hop acids” is meant any one or more of an alpha acid, beta acid, or derivative thereof. Accordingly, the term “hop acids” includes combinations of alpha acids, beta acids, and various derivatives thereof.

By “hop acid degradation” is meant a reduction in the amount of a hop acid in a composition. Hop acid degradation typically results from oxidation, light or acid catalyzed rearrangement.

By “increase” or “reduce” is meant any positive or negative alteration, respectively. Such alteration is by at least about 5%, 10%, 25%, 50%, 75% or 100%.

By “industrial antimicrobial” is meant an antimicrobial composition used to clean, sanitize, or disinfect a surface in any industrial setting. In various embodiments, industrial antimicrobials are used on walls, floors, ceilings, counters, and machinery present in factories, food processing facilities, and hospitals.

By “lipid encapsulated” is meant that a hop acid salt or derivative thereof interacts with a hydrophobic group present on a lipid. Lipids are known in the art, and include, but are not limited to, animal, vegetable, and synthetic saturated fats, unsaturated fats, mono unsaturated fats, polyunsaturated fats and trans fats. In one embodiment, hop acids of the invention are prepared in a lipid encapsulated formulation using partially hydrogenated soy bean oil.

By “home antimicrobial” is meant an antimicrobial composition used to clean, sanitize, or disinfect a surface with a home. In various embodiments, home antimicrobials are used in a kitchens, bathrooms, and other rooms within a dwelling to prevent or inhibit microbial growth on walls, floors, carpets, ceilings, counters, appliances, food preparation or storage vessels, or other implements used in food preparation.

By “product not subjected to the method” is meant a product lacking chemical or natural preservatives or a product contacted with a hop acid that is not an alkali metal hop acid salt or an alkaline earth metal hop acid salt.

By “shelf life” is meant the time that a product may be held in the absence of spoilage prior to consumption or use by a consumer.

By “inhibiting microbial growth” is meant preventing, slowing, or otherwise reducing the proliferation of a microbe. Such inhibition is by at least about 5%, 10%, 25%, 50%, 75%, or 100%.

By “mammalian” is meant any mammal. Exemplary mammals include, but are not limited to, humans, primates, cows, horses, pigs, sheep, dogs, cats, mice, rats, guinea pigs, and rabbits. Exemplary avian organisms include, but are not limited to, chickens, ducks, game hens, geese, and turkeys.

By “medium” is meant any composition capable of supporting the growth or survival of a microbe.

By “microbe” is meant a bacterium, fungus, protozoa, virus, or other microscopic organism. Microbes include airborne pathogens.

By “substantially free” is meant that the compound is, at least to some degree purified. Alpha acids and beta acids are preferably at least 50%, 75%, 85%, 90%, 95%, or even 99% pure.

By “water soluble” is meant capable of being dissolved in water. In one embodiment, a compound of the invention (e.g., a water soluble hop acid alkali metal salt) is dissolved in water or another aqueous composition to form a solution comprising between 1% and 70% of the compound, wherein the bottom of the range is any integer between 1% and 69%, and the top of the range is any integer between 2% and 70%. Exemplary solutions include 1%, 2%, 5%, 10%, 15%, 20%, 25%, 30%, 35%, 40%, 50%, 60%, 70%, 80%, 90%, or even 95%.

By “water insoluble” is meant largely insoluble or only sparingly soluble in water. Water insoluble compositions rarely form aqueous solutions having a concentration greater than 1-3%. Typically, water insoluble compositions are freely soluble in a variety of non-aqueous solvents, including ethanol, cremophor, dimethylsulfoxide (DMSO), dimethylformamide (DMF), isopropanol (IPA) or glycerol, or any other water miscible solvent.

### BRIEF DESCRIPTION OF THE DRAWINGS

FIG. 1 is a graph showing the bacteriostatic effects of beta acid sodium salts against B. subtilis Beta acid sodium salts significantly retarded bacterial growth for at least 3 days in the concentration range of 0.04 to 30 ppm.

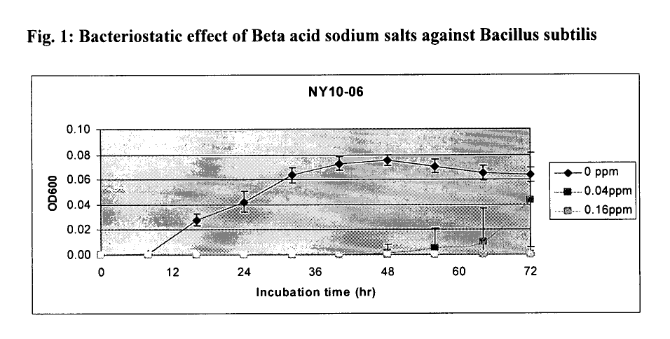

FIG. 2 is a graph showing the antimicrobial activity of beta acid sodium salts against E. Coli (wild). Beta acid sodium salts significantly retarded bacterial growth for 3 days in the concentration range of 0.04 to 30 ppm under the conditions.

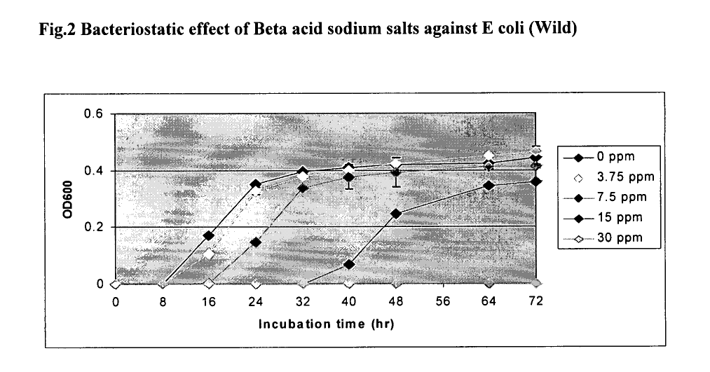

FIG. 3 is a graph showing that a combination of beta acid sodium salt and glycine synergistically inhibit bacterial growth. Glycine is known to show a relatively weak activity against Bacillus subtilis. Glycine alone showed almost no effect on bacterial growth when administered alone (purple dots). When combined with beta acid sodium salts, the combination showed enhanced efficacy (green dots).

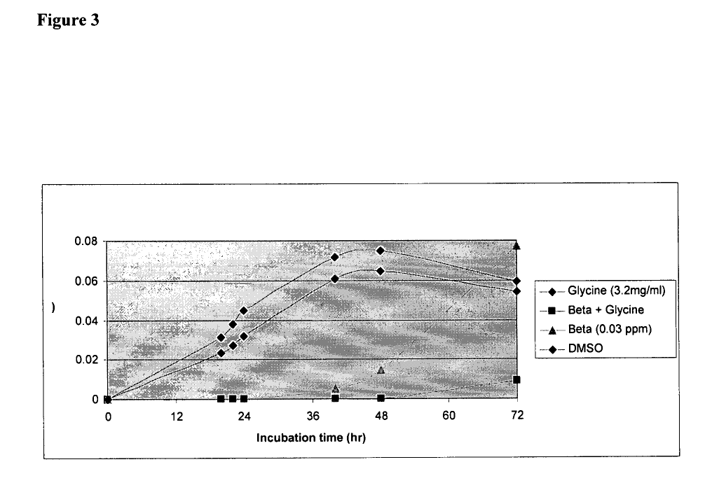

### DETAILED DESCRIPTION

The invention features compositions comprising one or more hop acid alkali metal salts (e.g., sodium, potassium, lithium), alkaline earth metal salts (e.g., calcium, magnesium) and other salts having enhanced stability relative to conventional hop acids. Hop acid alkali salts, which include both alpha and beta acid salts, are typically soluble in water and aqueous solutions. Alkaline earth metal salts are soluble in ethanol and other non-aqueous diluents. The invention also features methods of using anti-microbial compositions to prevent, reduce, inhibit, or slow the survival, growth, or proliferation of a microbe. In one embodiment, a composition of the invention is used to preserve or extend the life of a food product. In particular, hop acid alkali metal salts, alkaline earth metal salts, and derivatives thereof having anti-microbial activity are used to inhibit microbial growth in food products. In other embodiments, hop acid compositions of the invention may also be used as anti-microbials in industrial processing or industrial products, or may be used as anti-microbials in the home.

Anti-Microbial Compositions

Anti-microbial compositions of the invention include water soluble hop acid alkali metal salts (e.g., sodium, potassium, lithium salts) and water insoluble hop acid alkaline earth metal salts (e.g., calcium, magnesium). Such compositions are superior to existing hop products because the compositions of the invention remain stable under conditions that induce the degradation of conventional hop acids. In particular, after 6 months to 3 years or more of storage, the compositions of the invention are expected to retain at least about 50%, 60%, 75%, 80%, or preferably at least about 90%, 95% or even 100% of the hop acids present at the time of manufacture.

Water soluble hop acid alkali metal salts (e.g., sodium, potassium, lithium salts) and water insoluble hop acid alkaline earth metal salts (e.g., calcium, magnesium) are typically present in a diluent or carrier at levels ranging from about 0.1% to about 95%. The methods herein contemplate administration of an effective amount of compound or compound composition to achieve the desired or stated anti-microbial effect. The amount of active ingredient (e.g., hop acid alkali metal salts, hop acid alkaline earth metal salts) that may be combined with carrier materials (e.g., maltodextrin, clusterdextrin, corn starch, corn syrup solids, glucose, cyclodextrin, arabic gum, calaginan, inuline, partially hydrogenated soybean oil, cellulose, hydroxymethyl cellulose, hydroxyethyl cellulose, hydroxypropyl cellulose, rosin, hypomellose) or diluents, such as water, juices, other aqueous solutions, water miscible solvents (ethanol, cremophor, dimethylsulfoxide (DMSO), dimethylformamide (DMF), isopropanol (IPA) or glycerol, and other solvents) to form a solution or slurry depends upon the microbe that the product seeks to inhibit and the particular use in which the product will be employed. A typical preparation will contain from about 1% to about 95% hop acid, where the bottom of the range is any integer between 5 and 94 and the top of the range is any integer between 6 and 95, where the hop acids are provided in a carrier (e.g., maltodextrin, clusterdextrin, corn starch, corn syrup solids, glucose, cyclodextrin, arabic gum, calaginan, inuline, rosin, partially hydrogenated soybean oil, cellulose, hydroxymethy cellulose, hydroxyethyl cellulose, hydroxypropyl cellulose, hypomellose) that is suitable for use in methods of producing a product having resistance to microbial growth or proliferation. Where non-aqueous antimicrobial compositions are desired, the antimicrobials of the invention are preferably formulated with rosin or partially hydrogenated soybean oil. Such compositions may be used for the slow release of the active antimicrobial composition, for example, in an aqueous slurry. In another example, antimicrobials of the invention in slow release formulations are mixed in animal feed. In still other embodiments, antimicrobial compositions of the invention are dispersed in cellulose powder. In each of the aforementioned embodiments, the hop acid alkali metal (e.g., sodium, potassium, lithium), alkaline earth metal salts (e.g., calcium, magnesium), or other hop acid salts are dispersed or dissolved in water, ethanol, or another diluent together with any one or more of maltodextrin, clusterdextrin, corn starch, corn syrup solids, glucose, cyclodextrin, arabic gum, calaginan, inuline, rosin, partially hydrogenated soybean oil, cellulose, hydroxymethy cellulose, hydroxyethyl cellulose, hydroxypropyl cellulose, and hypomellose. The composition is then spray dried to facilitate the formation of particles less than 1 mm in size. Preferably, the conditions used for spray drying are adjusted such that the particles are at least about 1 μm, 5 μm, 10 μm, 25 μm, 50 μm, 75 μm, 100 μm, 150 μm, 200 μm, 500 μm, 1 mm, 2 mm, or 5 mm in size. The ratio of hop acids to carrier ranges between about 1:2 and 1:100. Preferred ratios include 1:2, 1:3, 1:4, 1:5, 1:6, 1:7, 1:8, 1:9, 1:10, 1:20, 1:30, 1:50, 1:75, and 1:100. Alternatively, compositions of the invention include at least about 1%, 10%, 20%, 30%, 50%, 60%, 75%, 80%, 90%, or 95% hop acid alkali metal (e.g., sodium, potassium, lithium) or hop acid alkaline earth metal salts (e.g., calcium, magnesium) in a diluent or carrier. Not all of the hop acids need be in the metal form. Anywhere between 5% and 100% of the hop acids present in the composition are in the metal form at any given time, and between 95% and 0% are present as free acids. In various embodiments, a composition of the invention contains hop acids where 90% are present in the metal form and 10% are present in the acid form; 50% are present in the metal form and 50% in the acid form; and 10% are present in the metal form and 90% in the acid form.

In preferred embodiments, the preparation includes between 1 and 95% (e.g., 1, 2, 3, 4, 5, 6, 7, 8, 9, 10, 25%, 75%, 80%, 90%, 95%) hop acids in a carrier or diluent. Alternatively, such preparations contain from about 20% to about 80% hop acids. Compositions containing alpha or beta acids are manufactured by ordinary methods. Hop acids suitable for addition to products can be formulated as ordinary tablets, capsules, solids, liquids, emulsions, slurries, fine granules or powders, which are suitable for administration to products during their preparation, following preparation but prior to storage, or at any time prior to their sale to a vendor or consumer. Lower or higher amounts than those recited above may be required. The compositions delineated herein include the compounds of the formulae delineated herein, as well as additional anti-microbial agents if present, in amounts effective for inhibiting microbial growth. References that include examples of additional anti-microbial agents are: 1) Burger's Medicinal Chemistry & Drug Discovery 6^{th} edition, by Alfred Burger, Donald J. Abraham, ed., Volumes 1 to 6, Wiley Interscience Publication, NY, 2003.

Anti-microbial compositions of the invention may be used in virtually any application where the inhibition of a microbe is desired. For example, compositions of the invention are used to prevent, reduce, inhibit, slow or stabilize the growth, proliferation, or survival of a microbe (e.g., Gram positive bacteria, Gram negative bacteria, fungus). In particular embodiments, anti-microbial compositions of the invention are used as food preservatives.

Food Preservatives

Hop acids are an attractive alternative to chemical preservatives. Advantageously, the present invention provides antimicrobials comprising hop acid alkali metal salts and alkaline earth metal salts that are resistant to degradation and exhibit enhanced stability. Hop acid salts having enhanced stability retain their anti-microbial efficacy and/or resist degradation for at least about 3 months, 6 months, or 9 months. Preferably, anti-microbial efficacy and/or degradation resistance is maintained for at least about 12 months, 18 months, 24 months, 36 months, or longer. Methods of assaying microbial growth are known to the skilled artisan. In one embodiment, anti-microbial efficacy is analyzed by assaying the growth of a microbe in the presence or absence of one or more hop acids. Hop acid degradation is assayed, for example, by detecting the presence or absence of a hop acid using spectrographic methods (e.g., mass spectrometer), chromatography (e.g., HPLC), or by any other methods known in the art.

For use in food products, compounds of the invention suitable carriers for the compositions herein include, for example, water, a base of fruit, vegetables or fruit or vegetable juice or puree, a base of vegetable soup or bouillon, a meat or fish broth, bouillon, paste, or other meat or fish product, a dairy, milk, or cheese food product, or any other food product known in the art. Anti-microbial compositions of the invention also can be added to a food product as a pure form or extracted hops. The food product can be a solid, a paste, or a liquid food product. Exemplary food products include, but are not limited to, animal-derived and plant-derived foodstuffs, such as sausages of all types (e.g., beef, pork, chicken, turkey, fish, etc.) primal and subprime cuts of meat, luncheon meats, hams, lamb, steak, hamburger, and poultry including chicken, turkey, duck, goose, as well as fish, and dairy products (e.g., semi-soft and hard cheeses, processed cheese, and cheese food), vegetable products, including lettuce, tofu, coleslaw, soybean products, milk, tea, soft drinks, juices, coffee, seasonings, cereals, water, cookies, yogurt, chewing gum, chocolate, or soups. The food product can be a “non-alcoholic” food product, that is a food product having low (e.g., <3%, <2%, <1%, <0.5%, <0.25%, <0.1%, <0.05%) or no (e.g., essentially zero) alcohol content.

Hop acid compositions useful for preventing, reducing, or slowing microbial growth may be added directly to a product (e.g., home product, industrial product, food product) prior to, during, or following processing of the product. Alternatively, the compositions of the invention are added to packaging materials that are intended to contact or encase the product prior to point of sale. Such packaging materials include, but are not limited to, wrappings (e.g., polymer, cellulose, food paper, or other wrapping materials), polymer films, casings (e.g., sausage casings), plastic containers or boxes, or any other material suitable for containing a food product. In another approach, a hop acid composition is applied to the surface of a food product at any time following the production of the product and prior to the point of sale to a vendor or consumer. Methods of applying anti-microbial compositions are known in the art and include sprinkling with a powder, dipping or immersing in an aqueous composition, or spraying with a powder, aqueous composition, or any other suitable composition comprising a hop acid or hop acid alkali salt. Preferably, the anti-microbial compositions of the invention are used to preserve foods against contamination with one or more food pathogens.

Food Pathogens

Food pathogens, particularly Listeria monocytogenes (Lm), are known contaminants of food products, such as meats, processed meats, and cheeses. Hop acids have antibacterial activities and are useful in reducing the growth of Listeria and other bacteria in food products. Hops or hops extracts are antimicrobial agents that can be used to inhibit microbial growth in food. See, for example, U.S. Pat. No. 5,286,506, which describes the use of 6 to 50 ppm beta acids extracted from hops to inhibit the growth of Listeria in food products; U.S. Pat. No. 5,455,038, which describes the use of tetrahydroisohumulone and/or hexahydrocolupulone at levels as low as 0.4 to 1.6 ppm to inhibit Listeria; U.S. Pat. No. 6,251,461, which describes the use of 1 to 100 ppm hop extract effective for inhibiting Clostridium botulinum, Clostridium difficile, and Helicobacter pylori); U.S. Pat. No. 6,379,720, which describes the use of about 0.01 to about 10,000 ppm hop extract to control biological fouling in water systems and process streams; and U.S. Pat. No. 6,451,365, which describes the use of hop acids and hop acid derivatives in combination with a gram positive bacteriostatic or bactericidal compound to control gram positive bacteria in food products; all of which are incorporated in their entirety.

Food Poisoning

Food poisoning is a disease caused by the ingestion of food contaminated by pathogenic bacteria, molds, viruses (e.g., coxsackie viruses, enteric adenovirus, hepatitis A, Norwalk and Norwalk-like viruses, rotavirus, parvovirus), and/or their toxins. Enteric diseases (e.g., those characterized by vomiting and diarrhea) are second only to respiratory diseases in prevalence. Nearly every U.S. citizen has at least one episode of enteric (diarrheal) disease annually, and foodborne diseases constitute approximately one-third of these diseases. Pathogen-contaminated food does not necessarily show any organoleptic sign of spoilage. Bacterial food poisoning may be caused by either infection of the host by the bacterial organism or by action of a toxin produced by the bacteria either in the food or in the host. Bacteria whose growth may be inhibited using compositions or methods of the invention include, but are not limited to, Aeromonas (e.g., A. hydrophila), Bacillus cereus, Campylobacter (e.g., C. jujuni), Claustridium (e.g., C. botulinum), Escherichia (e.g., E. coli, such as serotype 0157:H7), Listeria (e.g., L. monocytogenes), Salmonella (e.g., S. enteriditis), Shigella spp. (e.g., S. sonnei, S. flexneri, S. boydii) and Other Gram-Negative Bacteria, Staphylococcus (e.g., S. aureus), Vibrio (e.g., V. vulnificus), Yersinia (e.g., Y. enterocolitica).

Pasteurized and fully cooked processed foods are contaminated with microbes, such as Listeria monocytogenes, following cooking or pasteurization and prior to packaging for point of sale. Such contamination may be attributed to surface contamination caused by contact of microbes with food surfaces subsequent to heat treatment (i.e. cooking or pasteurization). Microbes may be airborne (i.e. carried by dust) or present on food contact surfaces, such as processing equipment. Particularly vulnerable to Listeria contamination are poultry and processed foods, such as wieners and other sausages, cheese, dairy products including novelty ice cream, and fish, seafood, and related products (e.g., fish paste).

Cleaning Compositions

Anti-microbial compositions containing water soluble hop acid alkali metal salts (e.g., sodium, potassium, lithium salts) and water insoluble hop acid alkaline earth metal salts (e.g., calcium, magnesium) may be employed in the form of aqueous or non-aqueous dilutions for application and used to sanitize a surface. By “sanitize” is meant prevent or treat microbial contamination of the surface. Desirably, compositions of the invention reduce microbial contaminants in the inanimate environment to levels considered safe according to public health ordinance. An anti-microbial of the invention may formulated as an aerosol, mist, spray, foam, liquid, wash, rinse, or as a bath to treat submerged items, articles or surfaces, and/or added to an aqueous system to treat submerged surfaces. Thus, a wide variety of suitable application methods include for example, but are not limited to, pouring, spraying, application with a trigger sprayer, aerosol sprayer or device containing a pressurized propellant and/or condensed gas, spraying onto a surface from a container attached to a hose, wiping onto a surface with a pre-moistened disposable device such as for example, but not limited to, a nonwoven wipe, cloth and/or sponge wetted with the inventive compositions. Suitable application methods include any method in which the inventive compositions are applied directly in either neat form, or concurrent with and/or following dilution of a concentrated composition with a suitable aqueous diluent, such as for example water.

In one representative embodiment, water soluble hop acid alkali metal salts (e.g., sodium, potassium, lithium salts) and water insoluble hop acid alkaline earth metal salts (e.g., calcium, magnesium) are formulated as concentrated mixtures of ingredients, optionally including a first aqueous or non-aqueous diluent (e.g., ethanol) that may be further diluted to prepare a ready-to-use solution. During use, and in order to sanitize or disinfect a surface, the inventive compositions are applied to and allowed to contact the surface for a proscribed time to effect microbial reduction or kill. After this contact time, the inventive compositions may be allowed to remain in place, or may optionally be wiped or removed from the surface by some suitable means. Optionally, the treated surface can be rinsed with water to remove the inventive compositions following treatment. Compositions of the invention may optionally include cleaning agents and other adjuncts and hence provide simultaneous cleaning and antimicrobial treatment of surfaces.

The antimicrobial compositions can be used in a household, commercial, restaurant, medical, business and/or outdoor environment. Surfaces to which the antimicrobial composition may be applied include, but are not limited to those made from metal, plastic, stone, glass, ceramic, painted surfaces, wallpaper, textiles, carpets, and the like. Antimicrobials of the invention may be used to sanitize any of the following: sink, tile, bathtub, shower wall, toilet bowl, kitchen countertop, tabletop, table covering, cutting board, eating utensil, stove top, oven, microwave oven, refrigerator, wall, floor, and/or window. Such surfaces are commonly found in households, hospitals, and food production facilities. In addition, the compositions can be used on the interior and exterior surfaces of common objects of construction, including, but not limited to exterior and interior surfaces of an airplane, automobile, bathtub, boat, building, fluid distributing system, household-appliance, household fixture, shower stall, sink, ship, sanitary closet, vehicle, water distribution system, water recirculation system, and/or combinations thereof, and further including the finished, laminated, coated and/or painted surfaces thereof.

If desired, compositions of the invention used as cleaners or sanitizers are provided in combination with an effective amount of one or more surfactants. Such surfactants include, but are not limited to, nonionic, semi-polar, anionic, cationic, zwitterionic, and/or amphoteric surfactants. In one aspect of this embodiment, the surfactant includes, but is not limited to, lauryl sulfate, laurylether sulfate, cocamidopropylbetaine, alkyl polyglycosides, and/or amine oxides. The surfactant content in and/or used in combination with the improved cleaning composition is about 0.1-2 weight percent. In yet a further aspect of this embodiment, the surfactant content in and/or used in combination with the improved cleaning composition is about 0.15-1.5 weight percent In still yet a further aspect of this embodiment, the surfactant content in and/or used in combination with the improved cleaning composition is about 0.2-1.5 weight percent. In another aspect of this embodiment, the surfactant content in and/or used in combination with the improved cleaning composition is about 0.2-1.25 weight percent. In yet another aspect of this embodiment, the surfactant content i is about 0.5-1.25 weight percent. In still another aspect of this embodiment, the surfactant content is about 0.1-1 weight percent. In still yet another aspect of this embodiment, the surfactant content is about 0.15-0.8 weight percent. In a further aspect of this embodiment, the surfactant content is about 0.2-0.4 weight percent. In yet a further aspect of this embodiment, the surfactant content is less than about 0.5 weight percent.

The cleaning or sanitizing composition typically includes water. When the improved cleaning composition is a liquid, water based, ready-to-use cleaner, the water content of the improved cleaning composition is generally over 50 weight percent of the improved cleaning composition. Typically, the liquid ready-to-use improved cleaning composition includes at least about 80 weight percent water; however, higher or lower water contents can be used.

One or more additional anti-microbial compounds can be included in and/or used in combination with the improved cleaning composition to enhance the biocidal efficacy of the cleaning composition. Such anti-microbial compounds include, but are not limited to, glycine, sodium actetate, sorbic acid, sodium dehydroacetate, sodium lactate, sodium benzoate, p-hydroxy benzoate, E-polylysine, milt protein, Lysozyme, or any plant derived antimicrobial components, alcohols, peroxides, boric acid and borates, chlorinated hydrocarbons, organometallics, halogen-releasing compounds, mercury compounds, metallic salts, pine oil, essential oils, organic sulfur compounds, iodine compounds, silver nitrate and other silver compounds, quaternary phosphate compounds, and/or phenolics.

Absorbent Materials

Antimicrobials of the invention can be used in conjunction with an absorbent and/or adsorbent material. Materials comprising antimicrobials of the invention are suitable for absorbing fluids that are contaminated with or are susceptible to contamination by a microbe, such as bodily fluids, secretions, or excretions. Bodily fluids, secretions, or excretions include, but are not limited to, blood, urine, saliva, serous fluid, synovial fluid, gastric secretions, cerebrospinal fluid, sweat, tears, bile, chyme, mucous, vitreous humor, lymph, wound exudate, feces, blood (e.g., menstrual blood), and semen. In one embodiment, an antimicrobial composition of the invention is incorporated into an aborbent fibrous or non-fibrous material suitable for use as a wound dressing, a medical sponge, a hemostatic article, a hemostatic article for the nose, an adhesive bandage, a wound packing, an internal vascular closure packing, an external vascular closure dressing, a swellable absorbent article, a fibrotic wound packing article, or a feminine hygiene product.

Hop Derivatives

A hop derivative is a compound that is chemically derived (either through natural biosynthetic processes (e.g., living organism metabolism (e.g., mammal, plant, bacteria)) or synthetic processes using human intervention (e.g., chemical synthesis)) from a hop plant. Compositions of the invention include one or more compounds derived from hops. Of particular interest are the hop acids. Hops contain two major organic acid classes, humulones (also known as alpha acids) and lupulones (also known as beta acids). Hop acids are the bitter acid components of hops that are used in beer making. There are three major analogs for alpha acids, co-humulone, n-humulone, and ad-humulone, and three major analogs for beta acids, co-lupulone, lupulone, and ad-lupulone. Alpha and beta acids can be prepared by purification from natural hops and also by chemical synthesis according to traditional methods.

Exemplary hop derivatives include rhoisoalpha acids, isoalpha acids, tetrahydroisoalpha acids, tetrahydroisoalpha acids, and hexahydroisoalpha acids. As used herein, the term “isoalpha acid” refers to compounds isolated from hops plant products and which subsequently have been isomerized. The isomerization of alpha acids can occur thermally, for example, by boiling. Examples of isoalpha acids include, but are not limited to, isohumulone, isocohumulone, and isoadhumulone. As used herein, the term “rhoisoalpha acids” refers to alpha acids isolated from hops plant product and which subsequently have been isomerized and reduced (e.g., using sodium borohydride) including cis and trans forms. Examples of rhoisoalpha acids include, but are not limited to, rhoisohumulone, rhoisocohumulone, and rhoadhumulone. As used herein, the term “tetrahydroisoalpha acids” refers to a class of reduced isoalpha acids produced by hydrogenation of isoalpha acids. Examples of tetrahydroisoalpha acids include, but are not limited to, tetrahydroisohumulone, tetrahydroisocohumulone and tetrahydroadhumulone. As used herein, the term “hexahydroisoalpha acids” refers to a class of reduced isoalpha acids, produced by hydrogenation of isoalpha acids and sodium borohydride reduction of the resulting tetrahydroisoalpha acids. Examples of hexahydroisoalpha acids include, but are not limited to, hexahydroisohumulone, hexahydroisocohumulone and hexahydroadhumulone.

Exemplary beta acids include, but are not limited to, hexahydrobeta acids and tetrahydrobeta acids, as well as magnesium salts of Redihop®, and potassium or magnesium salts of beta acids. As used herein, the term “beta acids” refers to compounds that can be isolated from hops plant products, including but not limited to, lupulone, adlupulone, colupulone, tetrahydrolupulone, tetrahydroadlupulone, tetrahydrocolupulone and their derivatives.

Exemplary hop derivatives include hop acids (e.g., alpha or beta acids) that include at least one dissociative moiety (e.g. enolic OH or phenolic OH).

Alpha acids and beta acids can be prepared by purification from natural hops and also chemical synthesis according to traditional methods. The compounds delineated herein can be synthesized using conventional methods known in the art.

Plant extracts are often used for the purification of compounds from plants (e.g., hops). An extract can be prepared by drying and subsequently cutting or grinding the dried material. The term “extract” refers to a concentrated preparation of the essential constituents of a plant (e.g., medicinal plant, hops). Typically, an extract is prepared by drying and powderizing the plant. The extraction process may then be performed with the help of an appropriate choice of solvent, typically supercritical or liquid carbon dioxide, ethanol/water mixture, methanol, butanol, iso-butanol, acetone, hexane, petroleum ether or other organic solvents by means of maceration, percolation, repercolation, counter-current extraction, turbo-extraction, or by carbon-dioxide supercritical (temperature/pressure) extraction. In preferred embodiments, a hop extract of the invention is prepared using extraction methods known in the art that employ organic solvents or liquid CO₂. The extract is then be further evaporated and thus concentrated to yield by means of air drying, spray drying, vacuum oven drying, fluid-bed drying or freeze-drying, the extract product.

Numerous methods are available for the chemical synthesis of candidate compounds. Such compounds can be synthesized from readily available starting materials using standard synthetic techniques and methodologies known to those of ordinary skill in the art. Synthetic chemistry transformations and protecting group methodologies (protection and deprotection) useful in synthesizing the compounds identified by the methods described herein are known in the art and include, for example, those such as described in R. Larock, Comprehensive Organic Transformations, VCH Publishers (1989); T. W. Greene and P. G. M. Wuts, Protective Groups in Organic Synthesis, 2nd ed., John Wiley and Sons (1991); L. Fieser and M. Fieser, Fieser and Fieser's Reagents for Organic Synthesis, John Wiley and Sons (1994); and L. Paquette, ed., Encyclopedia of Reagents for Organic Synthesis, John Wiley and Sons (1995), and subsequent editions thereof. Chemically synthesized alpha and beta acids can be separated from a reaction mixture and further purified by a method such as column chromatography, high-pressure liquid chromatography, or recrystallization. As can be appreciated by the skilled artisan, further methods of synthesizing the compounds herein will be evident to those of ordinary skill in the art. Additionally, the various synthetic steps may be performed in an alternate sequence or order to give the desired compounds.

The compounds of this invention may contain one or more asymmetric centers and thus occur as racemates and racemic mixtures, single enantiomers, individual diastereomers and diastereomeric mixtures. All such isomeric forms of these compounds are expressly included in the present invention. The compounds of this invention may also be represented in multiple tautomeric forms, in such instances, the invention expressly includes all tautomeric forms of the compounds described herein. All such isomeric forms of such compounds are expressly included in the present invention. All crystal forms of the compounds described herein are expressly included in the present invention. As used herein, the compounds of this invention, including the compounds of formulae described herein, are defined to include derivatives. Derivatives include compounds of the invention that are modified by appending appropriate functionalities to enhance desired properties.

The compounds of this invention may be modified by appending appropriate functionalities to enhance selective biological properties. Such modifications are known in the art and include those, which increase an anti-microbial activity, increase solubility, or increase heat, light, or oxidation stability.

Acceptable salts of the invention include those derived from appropriate inorganic and organic bases. Salts derived from appropriate bases include any monovalent cation, including but not limited to lithium, sodium, potassium, silver, copper, or divalent cation, including but not limited to magnesium, calcium, barium, chromium, manganese, iron, cobalt, nickel, copper, zinc, and cadmium. In particular embodiments, the salt is derived from alkali metals (e.g., sodium, potassium, lithium, calcium). This invention also envisions the quaternization of any basic nitrogen-containing groups of the compounds disclosed herein. Water or oil-soluble or dispersible products may be obtained by such quaternization.

Methods for Assaying Antimicrobial Activity

Specific dosage and administration regimens are determined empirically as described herein. Methods for determining the anti-microbial activity of a composition of the invention are known in the art. In one embodiment, antimicrobial activity is estimated by determining the number of microbes that survive incubation with the candidate anti-microbial using an assay for colony forming units. Such methods are described, for example, by Datta et al., Appl Environ Microbiol. 1997 October; 63(10): 4123-4126, Rhee et al., Appl Environ Microbiol. 2003 May; 69(5): 2959-2963; or by determining the effect of an antimicrobial on a bacterial colony of L. monocytogenes, as measured in an inhibitory halo assay (Dieuleveux et al., Appl Environ Microbiol. 1998 February; 64(2): 800-803). In one embodiment, a microscale assay is used (Barreteau et al., “A rapid method for determining the antimicrobial activity of novel natural molecules,” J Food Prot. 2004 September; 67(9):1961-1964).

Kits

Compositions of the invention may be provided in kits. Kits of the invention include an anti-microbial composition of the invention in a form that is suitable for administration to a food product. In some embodiments, the kit comprises a sterile container which contains an effective amount suitable for administration to a food product; such containers can be boxes, ampoules, bottles, vials, tubes, bags, pouches, blister-packs, or other suitable container forms known in the art. Such containers can be made of plastic, glass, laminated paper, metal foil, or other materials suitable for holding food preservatives.

If desired a composition of the invention is provided together with instructions for administering it to a food product susceptible to microbial contamination. The instructions will generally include information about the use of the composition for food preservation. In other embodiments, the instructions include at least one of the following: description of the expression composition; information regarding the concentration of the composition to be added to a food product; and/or references. The instructions may be printed directly on the container (when present), or as a label applied to the container, or as a separate sheet, pamphlet, card, or folder supplied in or with the container.

### EXAMPLES

### Example 1

### Preparation of Water-Soluble Beta Acid Sodium Salts

Step 1: Commercially available hop CO₂ extract (55%: Alpha acids, 30% Beta acids, 10% uncharacterized residue) (10 kg) is placed into Tank 1. CO₂ extracts are produced by natural carbon dioxide extraction of hops. Carbon dioxide is a natural solvent that eliminates residual solvents that typically present in hop extracts produced using hexane or ethylene chloride solvents. Food grade KOH (100 g) is dissolved in deionized water (20 L). The KOH solution is added into the Tank 1 and the mixture is stirred at 55-65° C. for 1 hour and then agitation is stopped to form two layers.

Step 2: The lower aqueous layer (15 L) is transferred into Tank 2. The crude beta acid potassium salts are cooled down to room temperature for two hours and then Celite is added (0.5% wt/wt mix) for 20-30 minutes. The resulting mixture is filtered through a Buchner type filtration apparatus under vacuum.

Step 3: The filtrate (10 L) is transferred to Tank 3 and heated to 70° C. with agitation and then acidified with 30% of aqueous H2SO4 until the mixture reaches pH 2-3. The agitation is stopped, and the mixture is allowed to form two layers. The upper layer (5 L), which is retained, contains about 70% beta acids.

Step 4: Aqueous NaOH solution (about 9 L) is added to the upper layer (3 L) and the pH is adjusted to pH 10-10.5 at 65° C. with agitation then active charcoal (Norit A 200 mesh) (2% wt/wt mix) is added to the solution, which is gently stirred for thirty minutes. The mixture is incubated overnight and then filtered. The filtrate is diluted with deionized water to achieve 10% beta acid sodium salts in an aqueous composition. Alternatively, the mixtures is passed over a column containing 60 mesh active charcoal.

### Example 2

### Preparation of Powder of Hop Beta Acid Sodium Salts

Hop beta acids are prepared as described in Example 1 with the following modification. In step 4 of Example 1, aqueous maltodextrin solution was prepared at pH 10 by mixing an aqueous beta acid sodium salts solution with maltodextrin, such that the hop acids to maltodextrin ration is 5:1 to 10:1 ratio after the filtration. The solution is dried by spray drying to obtain a pale yellow powder containing 5-10% beta acid sodium salts.

### Example 3

### Preparation of Hop Beta Acid Sodium Salts in 67% EtOH Solution

beta acids are prepared as described in Example 1 with the following modification. In step 4 of Example 1, 500 ml of the aqueous solution, which contains about 30% beta acid sodium salts is mixed with 1000 ml of 100% EtOH with stirring to form 67% pale yellow ethanol solution containing 10% beta acid sodium salts.

### Example 4

### Preparation of Beta Acid Sodium Salts in 90% EtOH Solution

500 ml of an aqueous solution containing about 30% beta acid sodium salts is neutralized with 0.1 NH₂SO₄. The beta acid-rich fraction is precipitated out at pH 7-9. The solid is separated and washed with water three times. The solid (200 g) is dissolved into 1700 ml of 100% EtOH under stirring. 100 ml of aqueous NaOH solution (16 g of NaOH and 84 ml of water) is added to the ETOH solution under stirring to form a pale yellow clear 90% ethanol solution that contains 10% beta acid sodium salt.

### Example 5

### Stability Study of Hop Acids

The following samples containing hop acids were incubated under aerobic conditions at 75° C. for 0-6 days. Liquid samples were dissolved in a volume of 0.1 ml

1. Beta acids rich hop extract (10%) in water (pH=7.0)

2. Powder of 10% Beta acids and 90% Maltodextrin

3. Powder of 5% Beta acid Na salts and 95% Maltodextrin

4. Powder of 10% Beta acid Na salts and 90% Maltodextrin

5. 10% beta acid Na salts in water (pH=10)

6. Hop extract with 10% hop beta acid Mg salts

Following this incubation, the presence of hop acids was assayed. After incubation of 20 mg of each sample at 75° C. under aerobic conditions, the sample was dissolved into 1 ml of 70% aqueous EtOH. The solution was diluted 50 times with methanol and then 20 uL of the diluted sample was injected into a high pressure liquid chromatography (HPLC) for analysis. The HPLC conditions used were:
Temperature: 35° C.
Eluent A: 10 mM Triethylammonium acetate/water
Eluent B: 10 mM Triethylammonium acetate/acetonitrile
Gradient: Eluent B=from 30% to 90% in 20 minutes then keep B=90% for 5 minutes
Detection: 370 nm for beta acids, 254 nm for other degradation peaks
Determination: Area under the curve of three peaks (15-17 min) at 370 nm
Authentic sample: International Calibration Extract 2 from American Society of Brewing Chemists
HPLC Type: Agilent HP1100 series with diode array detector.

As shown in Table 1, alkali salts of beta acids (sample 3, 4, and 5) were more stable than the neutral form of beta acids in neutral or acidic conditions (1, 2 and 6). The results of these studies are summarized in Table 1.

TABLE 1
Stability study of hop beta acids under force conditions

| | Beta acids remained (%) | | |
|---|---|---|---|
| | Period (Day) | | |
| Sample | 1 | 3 | 6 |
| 1 | 52 | 20 | 0 |
| 2 | 40 | 15 | 0 |
| 3 | 100 | 100 | 98 |
| 4 | 100 | 100 | 100 |
| 5 | 100 | 90 | 90 |
| 6 | 60 | 25 | 0 |

This method provides for the rapid assessment of the chemical stability of hop acid salts relative to the degradation observed in hop acids. The degradation observed after six days at 75° C. is equivalent to the degradation that would be expected if the hop acids and salts were stored for 6 months at room temperature.

### Example 6

### Anti-Microbial and Microbiostatic Assay

Antimicrobial susceptibility testing was performed using the broth dilution method. A stock solution of test substance was prepared in dimethyl sulfoxide (DMSO). The test substance or vehicle control was added to test wells containing selected microorganisms (1×10⁻⁴ to 5×10⁻⁵ CFU/ml) in cultures grown under controlled conditions. Nutrient broth suitable for culturing Escherichia coli Lactobacillus Plantarum, Listeria monocytogenes and Bacillus subtilis, and Soybean-Casein Digest broth suitable for culturing Staphylococcus aureus was used. After 1 to 2 days, culture growth was assayed with a spectrophotometer by monitoring the absorption at 600 nm. The minimum inhibitory concentrations were defined as the concentrations that completely inhibited microbial growth after 1-2 days.

Shelf-life extension assays were performed using the broth dilution method. Final inoculum concentration was 1×10⁻² to 3×10⁻² CFU/ml. Microbial growth was assayed with a spectrophotometer by monitoring the absorption at 600 nm after 2 to 3 days. For Staphylococcus aureus, after 0, 1, 2 and 3 days of incubation, samples were serially diluted and plated onto Soybean-Casein Digest agar. After incubation, colonies were counted. The results of this analysis are summarized in Table 2, which shows that the compositions of beta acid alkali salts were effective in inhibiting the growth of Gram-positive bacteria, Gram negative bacteria and fungi.

TABLE 2
Anti-microbial activity (MICs) of Hop beta acid
alkali salts against various microorganisms

| | | MIC (ppm) | |
|---|---|---|---|
| | | 10% aqueous Beta | 10% Beta acid |
| | Pathogen | acid sodium salts | Potassium salts |
| Gram (+) | Staphylococcus | 10 | 10 |
| | aureus | | |
| | Thermus species | >30 | >30 |
| | Bacillus subtilis | 3 | 3 |
| | Bacillus cereus | 3 | 3 |
| | Bacillus | >20 | >20 |
| | sterothermophilus | | |
| | L. plantarum | 30 | 30 |
| | Streptococcus | 3 | 3 |
| | mutans | | |
| Gram (−) | Leuconostoc | 8 | 8 |
| | mesenteroides | | |
| | E. coli (ATCC25922) | >200 | >200 |
| | E. coli (wild) | >100 | >100 |
| | Salmonella | >100 | >100 |
| | typhimurium | | |
| Fungi | Penicillinum | >100 | >100 |
| | citrinum (ATCC9849) | | |

### Example 7

### Preparation of Rhoisoalpha Acid Salts

An inorganic salt of rhoisoalpha acids is produced using any standard methods known in the art. In one embodiment, a rhoisoalpha acid is produced according to the following method.

An empty drum was placed on a scale and tared. To the drum was added 80 kg of a mixture of rhoisoalpha acids (30%) in deionized water (75 L) at room temperature. The mixture was subjected to gentle agitation to form an aqueous slurry. MgSO₄ (45 kg) was added to the slurry at one time and the agitation was continued for 5-10 minutes until the MgSO₄ was homogeneously distributed. After 10 minutes, a small sample was removed to determine whether the reaction had reached completion. This was determined using an HPLC to assay the presence of rhoisoalpha acids magnesium salt. When the reaction was complete, the mixture was removed and deionized water was added to adjust the concentration of rhoisoalpha acids magnesium salt to 15-17% having 83-85% water content. The mixture was then dried using standard methods. When the drying was completed, the flaky products were packed in aluminum coated polyethelene bags, heat sealed and stored at room temperature prior to analysis.

### Example 8

### Preparation of Rhoisoalpha Acids Calcium Salts

To prepare the calcium salt of rhoisoalpha acid, 300 grams of an aqueous 30% rhoisoalpha acid solution having a pH of 11 was mixed with 37 grams of CaCl₂-2H₂O, which had been mixed previously with 200 mL deionized water. This slurry was mixed until homogeneous. The slurry was then poured directly onto a drying tray and dried.

### Example 9

### Preparation of Rhoisoalpha Acids Lithium Salts

To prepare the lithium salt of rhoisoalpha acid, 300 grams of an aqueous 30% rhoisoalpha acid solution having a pH of 9 was mixed with 21 grams of LiOH—H₂O, which had been mixed previously with 300 mL deionized water. This slurry was mixed until homogeneous. The slurry was then filtered through a Buchner funnel to remove excess water and placed onto a drying tray and dried.

### Example 10

### Preparation of Rhoisoalpha Acids Calcium Salts

To prepare the calcium salt of rhoisoalpha acid, 300 grams of an aqueous 30% rhoisoalpha acid solution having a pH of 11 was mixed with 37 grams of CaCl₂-2H₂O, which had been mixed previously with 200 mL deionized water. This slurry was mixed until homogeneous. The slurry was then poured directly onto a drying tray and dried.

### Example 11

### Preparation of Rhoisoalpha Acids Potassium Salts

To prepare the potassium salt of rhoisoalpha acid, 300 grams of an aqueous 30% rhoisoalpha acid solution having a pH of 10 was mixed with 35 grams of K₂CO₃ which had been mixed previously with 300 mL deionized water. This slurry was mixed until homogeneous. The slurry was then poured directly onto a drying tray and dried.

### Example 12

### Preparation of Tetrahydroisoalpha Acid Calcium Salts

To prepare the calcium salt of tetrahydroisoalpha acid, 1000 grams of an aqueous 9% tetrahydroisoalpha acid solution having a pH of 10.5 was mixed with 42 grams of CaCl₂-2H₂O, which had been mixed previously with 100 mL deionized water. This slurry was mixed until homogeneous. The slurry was then filtered through a Buchner funnel to remove excess water and placed onto a drying tray and dried.

Virtually any hop acid alkali salt (e.g., sodium, potassium, lithium), hop acid alkaline earth metal salt (e.g., magnesium, calcium salts), or other hop acid salts may be used in the process set forth above. As set forth in the above examples, the invention provides processes for producing water soluble alkali salts or water insoluble alkaline earth metal salts of alpha acids or beta acids. Virtually any isoalpha acids, rhoisoalpha acids, tetrahydroisoalpha acids, hexahydroisoalpha acids, beta acids, hexahydrobeta acids, tetrahydrobeta acids, lupulone, colupulone, adlupulone or derivatives thereof may be used in the processes of the invention. In one embodiment, the concentration of hop acids present in the aqueous solution ranges between 5% and 50%, inclusive. In other embodiments, the concentration ranges between 5-45% (e.g., 9%, 10%, 15%, 20%, 25%, 30%, 35%, 40%, and 45%), inclusive. In yet other embodiments, the lower end of the range is any number between 9 and 49%; and the upper end of the range is any number between 10 and 50%. The hop acids of step 4 may be dried to obtain salts any standard method or combination of methods, including but not limited to, spray drying, vacuum drying, drum drying, pan drying, window drying and freeze drying. Preferably, spray drying is used.

This process provides advantages over previous methods for producing salts of hop acids, which are susceptible to degradation due to heat, light, and acid catalysis.

Compounds of the invention are prepared in a manner essentially as described above and in the general schemes. The recitation of a listing of chemical groups in any definition of a variable herein includes definitions of that variable as any single group or combination of listed groups. The recitation of an embodiment for a variable herein includes that embodiment as any single embodiment or in combination with any other embodiments or portions thereof. Another embodiment is a compound of any of the formulae herein made by a process delineated herein, including the processes exemplified in the schemes and examples herein. Another aspect of the invention is a compound of any of the formulae herein for use in as an antimicrobial as delineated herein.

All references cited herein, whether in print, electronic, computer readable storage media or other form, are expressly incorporated by reference in their entirety, including but not limited to, abstracts, articles, journals, publications, texts, treatises, internet web sites, databases, patents, and patent publications.

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for preventing or inhibiting microbial growth in a product, the method comprising contacting the product with an effective amount of a hop acid salt selected from the group consisting of sodium, potassium, lithium, calcium, and magnesium thereby preventing or inhibiting microbial growth in the product.

2. The method of claim 1, wherein the product is a food product, an industrial product or a home product.

3. The method of claim 1, wherein the method increases the amount of time the product may be held in the absence of spoilage prior to consumption by a consumer or increases the shelf life of the product relative to a product not subjected to the method.

4-7. (canceled)

8. The method of claim 1, wherein the hop acid salt is a water soluble alkali metal salt or a water insoluble alkaline earth metal salt.

9. The method of claim 1, wherein the hop acid salt is a water insoluble alkaline earth metal salt.

10. The method of claim 1, wherein at least about 1%-90% of the hop acids are in the metal salt form.

11. The method of claim 1, wherein at least about 10%-90% of the hop acids are in the acid form.

12. A method for preventing or inhibiting microbial growth on a surface, the method comprising contacting the surface with an effective amount of a hop acid salt selected from the group consisting of sodium, potassium, lithium, calcium, and magnesium, thereby preventing or inhibiting microbial growth on the surface.

13. (canceled)

14. The method of claim 12, wherein the surface is a wall, floor, ceiling, counter, machine, or other surface or equipment present in an industrial, commercial, or clinical setting.

15-18. (canceled)

19. A method of sanitizing or disinfecting a body part, the method comprising contacting the body part with an effective amount of a hop acid salt selected from the group consisting of sodium, potassium, lithium, calcium, and magnesium, thereby sanitizing or disinfecting the body part.

20-23. (canceled)

24. A method for preventing or inhibiting a food borne disease, the method comprising contacting a food product with an effective amount of a hop acid salt selected from the group consisting of sodium, potassium, lithium, calcium, and magnesium.

25. The method of claim 11, wherein the hop acid salt is added to the food product prior to, during, or after processing of the food product.

26. The method of claim 11, wherein the contacting results in a food product comprising about 0.1 to 60 ppm or about 0.04 to 30 ppm hop acid salts.

27. (canceled)

28. The method of claim 1, wherein the hop acid salt is an alkali metal salt selected from the group consisting of sodium, lithium, and potassium.

29. The method of claim 28, wherein the hop acid alkali metal salt is provided in an aqueous solution.

30. The method of claim 1, wherein the hop acid salt is an alkaline earth metal salt that is magnesium or calcium.

31. (canceled)

32. The method of claim 1, wherein the hop acid alkali metal salts have increased stability relative to a conventional hop acid.

33-34. (canceled)

35. The method of claim 24, wherein the method inhibits a bacteria is selected from the group consisting of Bacillus Subtilis, Lactobacillus, Aeromonas, Bacillus cereus, Campylobacter, Claustridium, Escherichia, Listeria, Salmonella, Shigella spp., Staphylococcus, Vibrio, Yersinia, and Listeria.

36-88. (canceled)

89. A food packaging material comprising hop acid alkali metal salt.

90. The food packaging material of claim 89, wherein the packaging material is selected from the group consisting of polymer films, paper wrapping, paper, or meat casings.
